(19) United States
(12) Patent Application Publication
(10) Pub. No.: US 2019/0064043 A1
(43) Pub. Date: Feb. 28, 2019

(54) INDENTATION TESTING DEVICE AND INDENTATION TESTING METHOD

(71) Applicant: TEC GIHAN CO., LTD., Uji-city (JP)

(72) Inventors: Kazumi KOUKETSU, Uji-city (JP); Atsushi SAKUMA, Kyoto-shi (JP)

(21) Appl. No.: 16/176,513

(22) Filed: Oct. 31, 2018

Related U.S. Application Data
(63) Continuation of application No. PCT/JP2017/017609, filed on May 9, 2017.

(30) Foreign Application Priority Data
May 10, 2016 (JP) 2016-094937

(51) Int. Cl. G01N 3/42

(52) U.S. Cl. CPC G01N 3/42; G01N 2203/0082

(57) ABSTRACT

An indentation testing device that pushes an indenter into a sample, includes: an enclosure having a pressing surface to be pressed against the sample; the indenter, which is disposed so as to protrude from the pressing surface by a predetermined amount and is pushed into the sample; a load cell that is disposed between the enclosure and the indenter and that measures at least a force parallel to the indentation direction and acting on the indenter; and a Young's modulus display unit that calculates and displays the Young's modulus of the sample on the basis of the force acting on the indenter when the pressing surface comes into contact with the sample, as measured with the load cell.

### CROSS REFERENCE TO RELATED APPLICATIONS

This application is a continuation application of International PCT Application PCT/JP2017/017609 which was filed on May 9, 2017, which claims priority to Japanese Patent Application No. 2016-094937 which was filed on May 10, 2016, the entire contents of which are incorporated herein by reference.

### TECHNICAL FIELD

The present disclosure relates to a novel indentation testing method for measuring the softness of a test object. The present disclosure also relates to a novel indentation testing device using the indentation testing method.

### BACKGROUND

A tensile test used to examine elastic properties such as deformation of a metal material is typical as an objective evaluation method, but there is a need to cut out a test piece from a sample or the like and evaluate the test piece. Due to this high invasiveness, it is difficult to apply the test to a material that cannot be cut out because it is a soft product, or a living body tissue.

On the other hand, an indentation test also typically used in material hardness measurement allows less-invasive measurement of even a soft material or a living tissue because it is not necessary to cut out a test piece. It is known that this indentation test is based on the Hertzian elastic contact theory and can measure a metal material with high reliability (see, for example, NPL 1).

FIG. 1 is a schematic diagram of a typical indentation test. In the above-mentioned Hertzian elastic contact theory, when the amount of indentation when a spherical indenter 1 is pushed into a measurement sample 2 is denoted by δ, the force F acting on the spherical indenter 1 is expressed by the following equation using the Poisson ratio v and the diameter ϕ of the spherical indenter.

$$F = \frac{4}{3} \frac{E}{1 - {υ}^{2}} {( \frac{φ}{2} )}^{\frac{1}{2}} {δ}^{\frac{3}{2}} \qquad [ Equation 1 ]$$

It has been shown by Toshiyuki Sawa that measurement based on the Hertzian elastic contact theory using the indentation test described above can be performed with high reliability in measuring the configuration of a soft material with a large deformation such as living soft tissue. Similar indentation tests have been shown which are used to measure the configuration of a soft material with large deformation such as living soft tissue (see, for example, NPLs 2 to 5). The inventors of the present application has disclosed related technical contents (see, for example, NPLs 6 to 9 and PTL 1). However, it is not possible to realize an indentation testing device that has a simple structure, is small in size, light in weight, and low in cost.

### CITATION LIST

### Non Patent Literature

NPL 1: T. Sawa, Practical Material Mechanics, (2007), pp. 258-279, Nikkei Business Publications, Inc. (in Japanese)

NPL 2: O. Takatani, T. Akatsuka, The Clinical Measurement Method of Hardness of Organism, Journal of the Society of Instrument and Control Engineers, Vol. 14, No. 3, (1975), pp. 281-291. (in Japanese)

NPL 3: Y. Arima, T. Yano, Basic Study on Objectification of Palpation, Japanese Journal of Medical Electronics and Biological Engineering, Vol. 36, No. 4, (1998), pp. 321-336. (in Japanese)

NPL 4: N. E. Waters, The Indentation of Thin Rubber Sheets by Spherical indentors, British Journal of Applied Physics, Vol. 16, Issue 4, (1965), pp. 557-563.

NPL 5: T. Ishibashi, S. Shimoda, T Furukawa, I. Nitta and H. Yoshida, The Measuring Method about Young's Modulus of Plastics Using the Indenting Hardness Test by a Spherical Indenter, Transactions of the Japan Society of Mechanical Engineers, Series A, Vol. 53, No. 495, (1987), pp. 2193-2202. (in Japanese)

NPL 6: M. Tani, A. Sakuma, M. Ogasawara, M. Shinomiya, Minimally In vasive Evaluation of Mechanical Behavior of Biological Soft Tissue using Indentation Testing, No. 08-53, (2009), pp. 183-184.

NPL 7: M. Tani, A. Sakuma, Measurement of Thickness and Young's Modulus of Soft Materials by using Spherical Indentation Testing, No. 58, (2009), pp. 365-366.

NPL 8: A. Sakuma, M. Tani, Spherical Indentation Technique for Low-invasive Measurement for Young's Modulus of Human Soft Tissue, No. 09-3, (2009), pp. 784-785.

NPL 9: M. Tani and A. Sakuma, M. Shinomiya, Evaluation of Thickness and Young's Modulus of Soft Materials by using Spherical Indentation Testing, Transactions of the Japan Society of Mechanical Engineers, Series A, Vol. 75, No. 755, (2009), pp. 901-908. (in Japanese)

### Patent Literature

PTL 1: Japanese Patent No. 4967181

### SUMMARY

The present disclosure has been made in view of the problems described above, and an object of the present disclosure is to provide a novel indentation testing method that is simple, compact, lightweight, and inexpensive. Another object of the present disclosure is to provide a novel indentation testing device using the indentation testing method.

In a first aspect of the present disclosure, an indentation testing device that pushes an indenter into a sample, includes: an enclosure having a pressing surface to be pressed against the sample; the indenter, which is disposed so as to protrude from the pressing surface by a predetermined amount and is pushed into the sample; a load cell that is disposed between the enclosure and the indenter and that measures at least a force parallel to the indentation direction and acting on the indenter; and a Young's modulus display unit that calculates and displays the Young's modulus of the sample on the basis of the force acting on the indenter when the pressing surface comes into contact with the sample, as measured with the load cell.

In a second aspect of the present disclosure, an indentation testing method in which an indenter is pushed into a sample, includes: until a pressing surface of an enclosure comes into contact with the sample, pushing the indenter, which protrudes from the pressing surface by a predetermined amount, into the sample; measuring at least a force parallel to the indentation direction and acting on the indenter with a load cell disposed between the enclosure and the indenter; and calculating the Young's modulus of the sample on the basis of the force acting on the indenter when the pressing surface comes into contact with the sample, as measured with the load cell.

According to the present disclosure, it is possible to provide a novel indentation testing method and indentation testing device which is compact and lightweight and which can measure the softness of an object with high accuracy regardless of the orientation of the device.

### BRIEF DESCRIPTION OF DRAWINGS

FIG. 1 is a schematic diagram of an indentation unit;

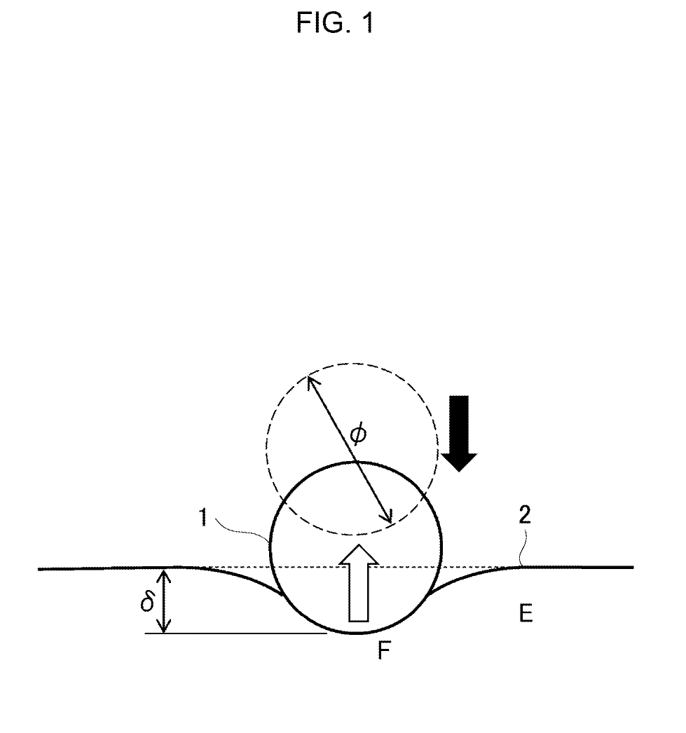

FIG. 2 is a schematic diagram of an indentation unit;

FIG. 3 is a perspective view of the appearance of an indentation testing device;

FIG. 4 is a perspective view of the appearance of an indentation testing device in which the indentation unit and the Young's modulus display unit are separated and connected by a signal line;

FIG. 5 is a perspective view of the appearance of an indentation testing device in which the indentation unit and the Young's modulus display unit are separated and wirelessly connected;

FIG. 6 is a perspective view of the appearance of an indentation testing device in which the indentation unit and the Young's modulus display unit are separated and a device such as a PC or a tablet is used as the Young's modulus display unit;

FIG. 7 is a schematic diagram of the indentation in the case where the sample to be measured is thin;

FIG. 8 is a schematic diagram of an indentation unit for determining the coefficient B;

FIG. 9 is a schematic diagram of an indentation unit for measuring two forces Fz and Fx of the pressing force the sample and the force generated when the contact surface with the sample is moved, by using a biaxial sensitivity load cell;

FIG. 10 is a schematic diagram showing changes in the forces Fz and Fx, which can be measured by push and move shown in FIG. 9;

FIG. 11 is a schematic diagram showing a state in which measurement is performed while moving the contact surface between a sample having a three-dimensional shape and the indentation unit;

FIG. 12 is a schematic diagram of an indentation testing device capable of changing the amount δ of protrusion of the indenter;

FIG. 13 is a conceptual diagram illustrating a case where a sample the surface friction coefficient of which varies depending on the location is measured; and

FIG. 14 is a conceptual diagram illustrating a case where a sample that has a uniform surface friction coefficient but has a region having a small thickness is measured.

### DETAILED DESCRIPTION

Hereinafter, a description will be given of embodiments for carrying out the present disclosure relating to an indentation testing method and an indentation testing device.

The indentation testing device, which is an indentation testing device for indenting a sample with an indenter, detects a force caused by indentation with a load cell installed in the indenter, and measures the Young's modulus of the sample from the indentation force on the basis of the Hertzian elastic contact theory. The indentation testing method, which is an indentation testing method for indenting a sample with an indenter, includes detecting a force acting on the indenter with a load cell when the indenter installed in the indentation testing device is pushed into the sample, and calculating the Young's modulus of the sample on the basis of the Hertzian elastic contact theory.

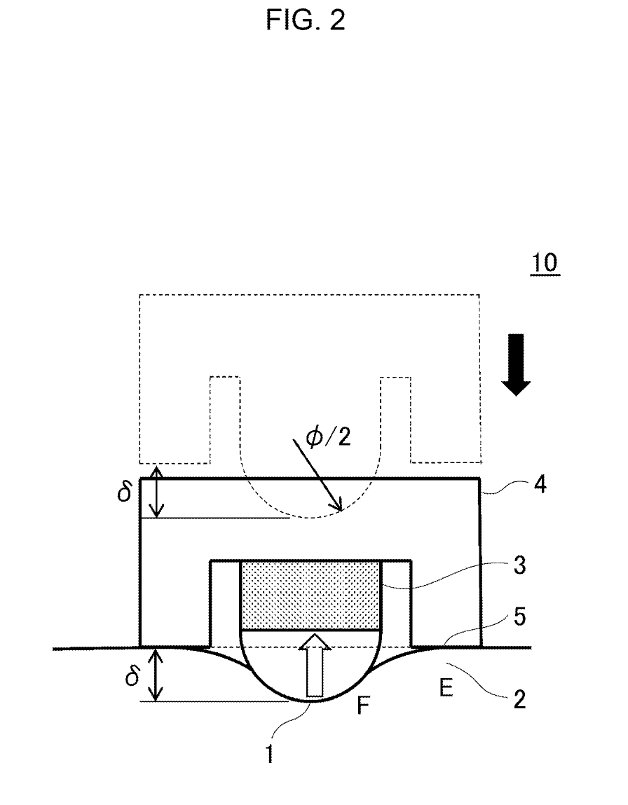

FIG. 2 is a schematic diagram of an indentation unit 10. In the following description, components having the same function are denoted by the same reference numeral. The indentation unit 10 has an enclosure (also referred to as a case) 4, and an indenter 1 is fixed to the enclosure 4 via a load cell 3. The indenter 1 protrudes from the pressing surface 5 by a predetermined amount δ so as to be pushed into the sample when the enclosure 4 is pressed against the sample 2. The load cell 3 disposed between the enclosure 4 and the indenter 1 measures and outputs at least a force parallel to the indentation direction and acting on the indenter 1. The pressing surface 5 of the enclosure 4 to the sample may be a flat surface or a curved surface having a curvature matching the surface property of the sample. The load cell 3 may be of a strain gauge type or a load cell of another type. When a sufficiently hard spherical indenter is pushed into the sample 2, the relationship between the indentation load F and the Young's modulus E of the sample shown in FIG. 2 is expressed using the Hertzian elastic contact theory as follows.

$$E = \frac{3}{4} ( 1 - {υ}^{2} ) {( \frac{φ}{2} )}^{- \frac{1}{2}} {δ}^{- \frac{3}{2}} F \qquad [ Equation 2 ]$$

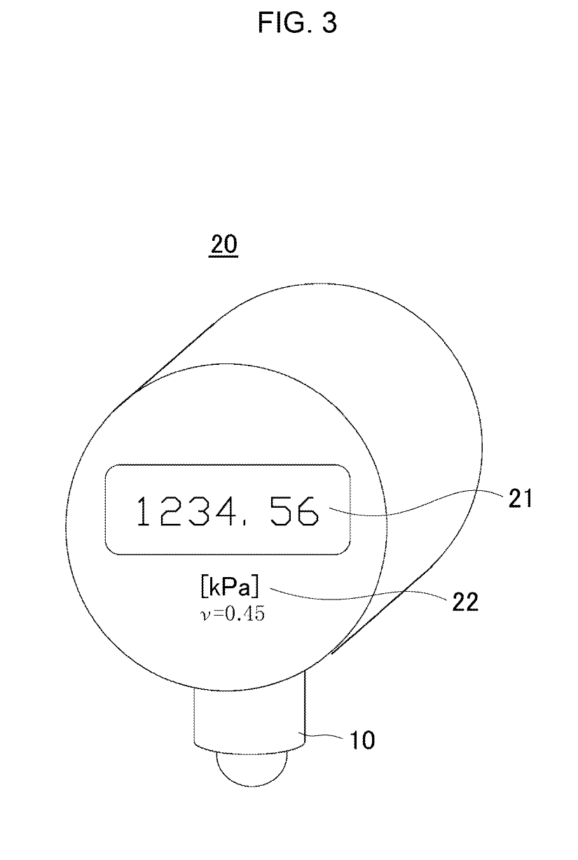

FIG. 3 is a perspective view of the appearance of an indentation testing device 20. The indentation testing device 20 includes an indentation unit 10, a Young's modulus display unit 21 for calculating and displaying the Young's modulus E using the above equation (Equation 2), and a Poisson's ratio display unit 22 for displaying in advance the Poisson's ratio v used in the calculation of the Young's modulus calculation unit by printing or the like. The indentation testing device 20 is large enough to fit in the palm as a whole. That is, it is simple, compact, lightweight, and inexpensive indentation testing device. The indentation testing device 20 may have a long rod shape, and the Young's modulus display unit 21 may be embedded in the rod.

In the indentation testing device 20, the Young's modulus display unit 21 calculates the Young's modulus E of the sample 2 on the basis of the diameter ϕ of the indenter, the Poisson ratio v of the sample 2, and the amount δ of protrusion of the indenter 1 from the pressing surface 5 which are previously given as data, by substituting the value of the force F acting on the indenter 1 measured with the load cell 3 into the above Equation 2, and displays it. The indentation testing device 20 may output the Young's modulus E as data to the outside.

In the indentation testing device 20, by relatively moving the pressing surface 5 while pressing it against the sample 2, the Young's modulus E at each point in the sample 2 can be continuously calculated. Since the reaction force received by the indenter 1, the amount δ of indentation of which is predetermined, can be obtained directly from the load cell 3, the amount δ of indentation does not change as in the case of using a spring, and therefore the accuracy of the measurement of the Young's modulus E can be improved.

A plurality of indentation testing devices 20 may be prepared for each Poisson ratio, and the indentation testing devices 20 may be selectively used according to the Poisson ratio of the sample 2. Alternatively, the indentation testing device 20 may have an input unit such as a numeric keypad so that the user can input the Poisson ratio. In that case, it is preferable that the Poisson ratio display unit 22 be configured to display arbitrary numbers as in the Young's modulus display unit 21 instead of the fixed display such as printing.

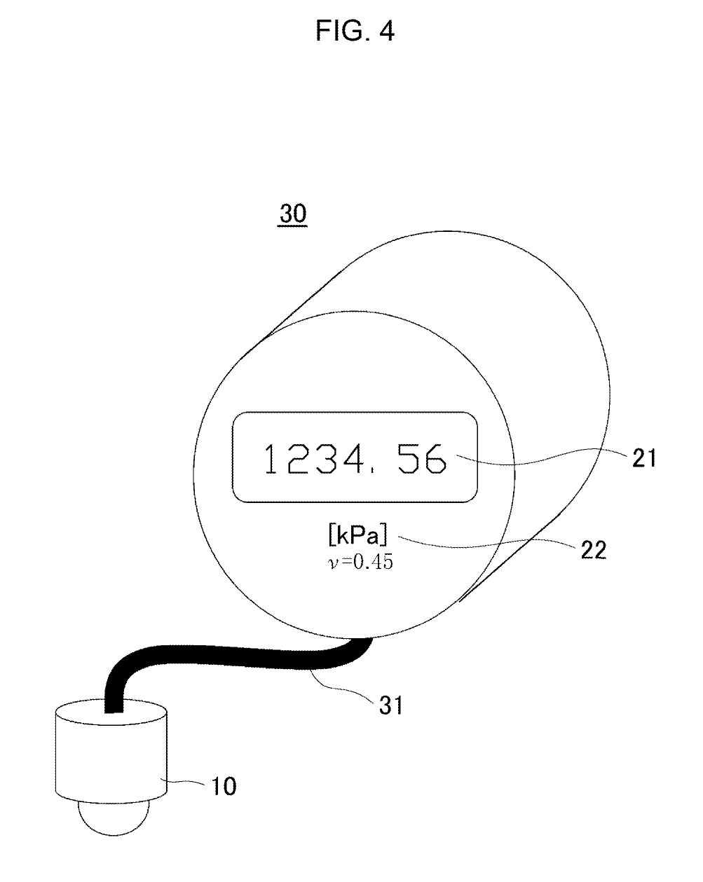

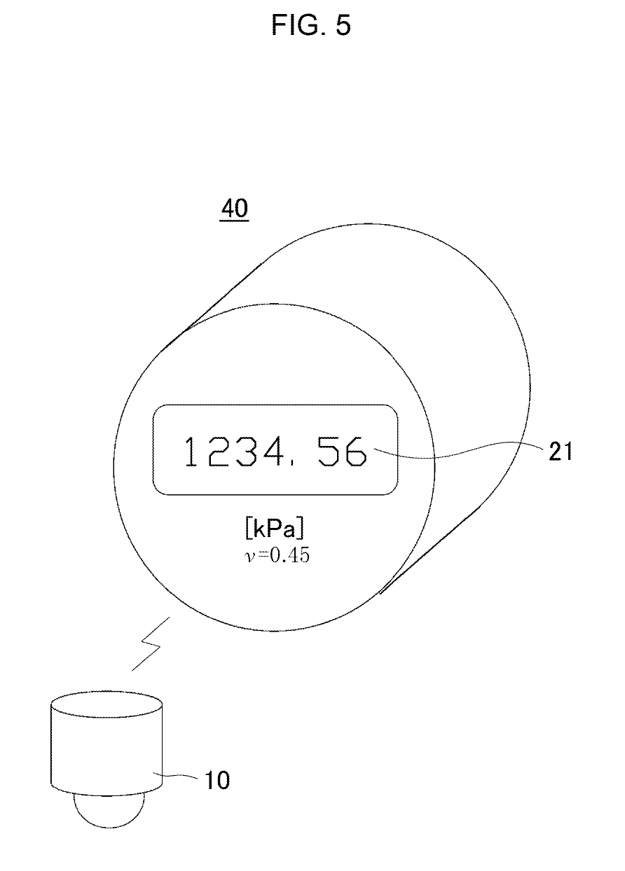

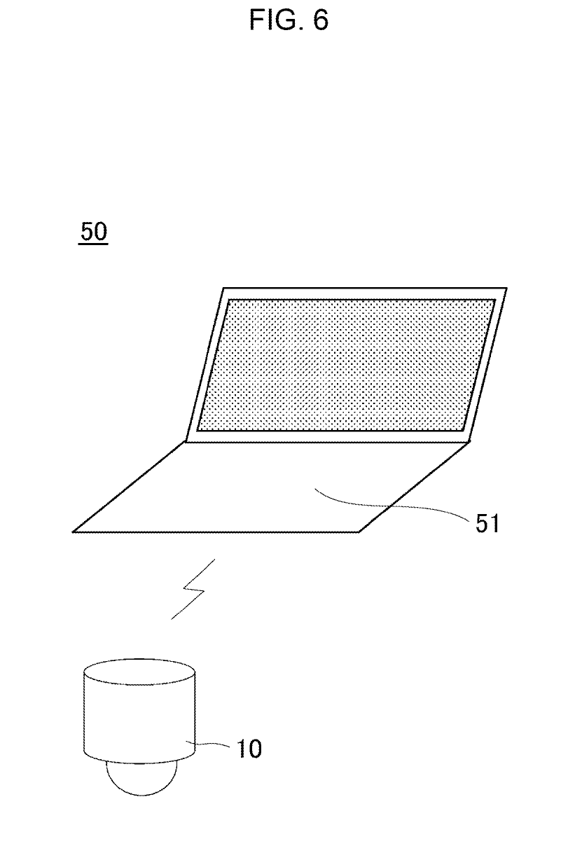

FIGS. 4, 5 and 6 are perspective views of the appearance of other indentation testing devices 30, 40 and 50. The indentation testing device 30 shown in FIG. 4 is of a type in which the indentation unit 10 and the Young's modulus display unit 21 are separated and connected by a signal line 31. FIG. 5 shows an indentation testing device 40 of a type in which the indentation unit 10 and the Young's modulus display unit 21 are separated and wirelessly connected. FIG. 6 shows an indentation testing device 50 of a type in which the indentation unit 10 and the Young's modulus display function are separated and a device such as a PC 51 or a tablet is used as the Young's modulus display unit.

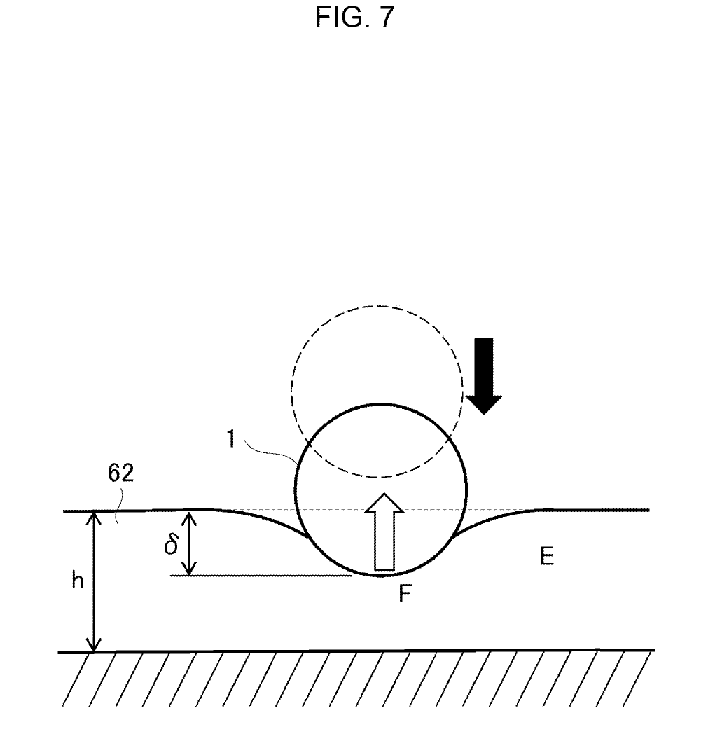

When the sample 62 whose Young's modulus E is to be measured shown in FIG. 7 is thin, the calculation formula based on the Hertzian elastic contact theory shown in Equation 1 cannot be accurately applied. In this case, the following equation concerning the load F including the thinness coefficient B described in PTL 1 is considered. That is, by applying the following equation, the relationship between the indentation load F and the decreased stroke amount δ can be expressed with high accuracy.

$$F = A {\{ ( 1 + B δ ) δ \}}^{\frac{3}{2}} where A = \frac{4}{3} \frac{E}{1 - {v}^{2}} {( \frac{ϕ}{2} )}^{\frac{1}{2}} \qquad [ Equation 3 ]$$

Here, B is a coefficient representing the influence of the thinness of the sample on the indentation load F on the indenter 1. The Young's modulus E can be determined in the same way as the measurement shown in FIG. 2 by determining the coefficient B representing the influence on the indentation load F from the measurement result of the indentation load F and the decreased stroke amount δ, even for a thin sample.

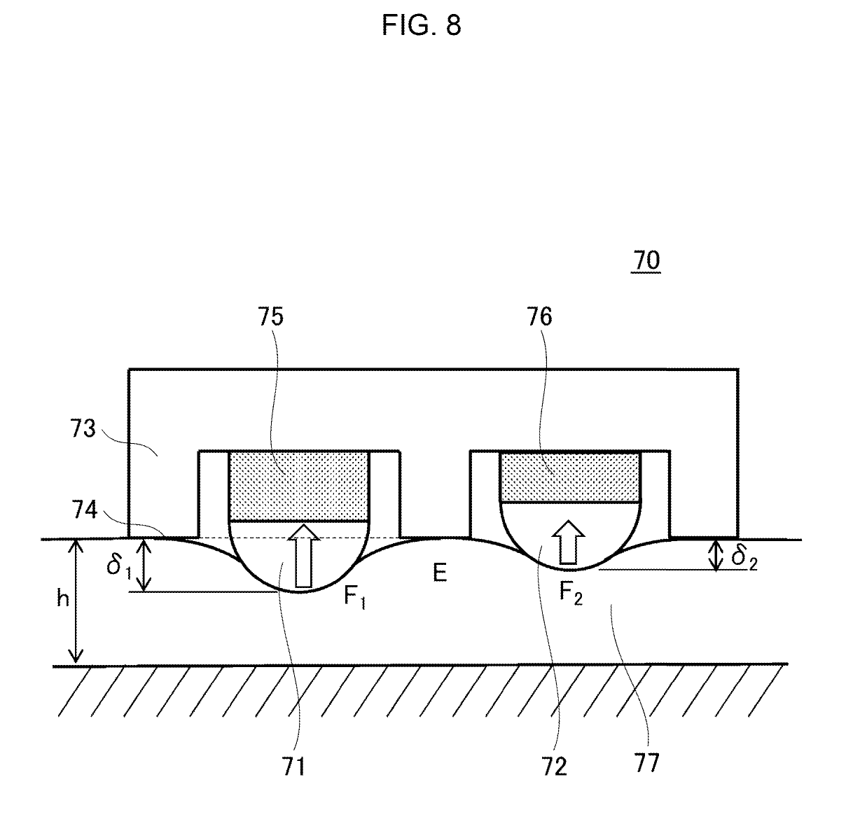

FIG. 8 is a schematic diagram of an indentation testing device 70 capable of simultaneously determining the coefficient B and the Young's modulus E. The indentation testing device 70 has an indenter 71 and a load cell 75 connected to the indenter 71, and an indenter 72 and a load cell 72 connected to the indenter 72. The other configuration is the same as that of the indentation testing device 30.

The two indenters 71 and 72 are configured so as to have different amounts δ₁ and δ₂, respectively, of protrusion from the pressing surface 74 of the enclosure 73. Although the coefficient B is unknown, the coefficient B which is unknown can be determined by determining the two forces F1 and F2 received by the indenters having two amounts δ₁ and δ₂ of protrusion with the load cells 75 and 76 when the indenters 71 and 72 are pressed against the sample 77 such that the pressing surface 74 is in contact with the measurement sample 77, and substituting them into the above Equation 3. By simultaneously solving two equations for two unknowns, the coefficient B and the Young's modulus E, the coefficient B and the Young's modulus E can be calculated simultaneously. In the shown configuration in which indenters are arranged side by side, there is the advantage that the distribution of Young's modulus can be determined.

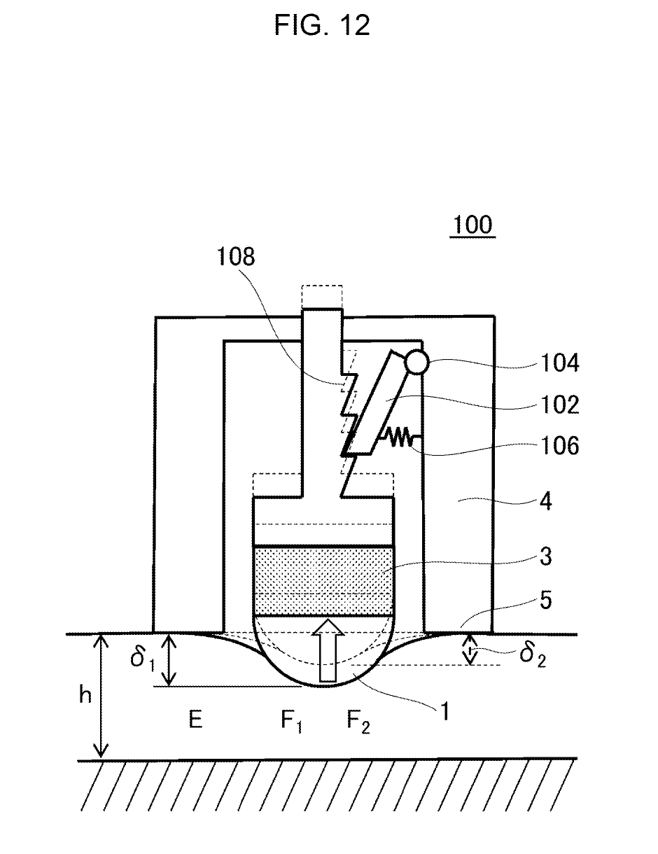

Although FIG. 8 shows a configuration in which two indenters having different amounts of protrusion from the enclosure are arranged side by side, the amount of protrusion of one indenter may be changed. FIG. 12 is a schematic diagram of an indentation testing device 100 capable of changing the amount δ of protrusion of the indenter 1. In the indentation testing device 100, the load cell 3 is fixed to a plurality of ratchet teeth 108. The enclosure 4 is provided with a ratchet pawl 102 that pivots around a fulcrum 104. The ratchet pawl 102 is urged toward the ratchet teeth 108 by the urging force of a spring 106.

Depending on the meshing position of the ratchet teeth 108 and the ratchet pawl 102, the indenter 1 can be set to different amounts δ₁, δ₂, and so forth of protrusion. In this case, there is the advantage that the number of load cells 3 is one and the price can be reduced.

Instead of simultaneously solving equations using a plurality of amounts 6 of protrusion and indentation force F, the relationship between the thickness of the sample 2 and the coefficient B may be formulated and stored in the memory of the display unit 21 so that the user can input the value of the thickness of the sample 2. In this case, instead of the inputting by the user, a sensor for measuring the thickness may be provided in the indentation testing device 30 or the like so that the value of the thickness measured by the sensor is input.

A method and a device for measuring the Young's modulus E by determining the reaction force in the pressing direction generated when the indenter of the device is pushed into the sample has been described. In this device, since the indenter is fixed to the enclosure via the load cell, it is possible to maintain a stable posture in both the vertical and horizontal directions. Therefore, in addition to the reaction force in the pressing direction (that is, the pressing force) generated when the indenter is pushed in, the force generated when the contact surface is moved while the indenter of the device is pushed into the sample (that is, the apparent frictional force) can also be measured with the load cell.

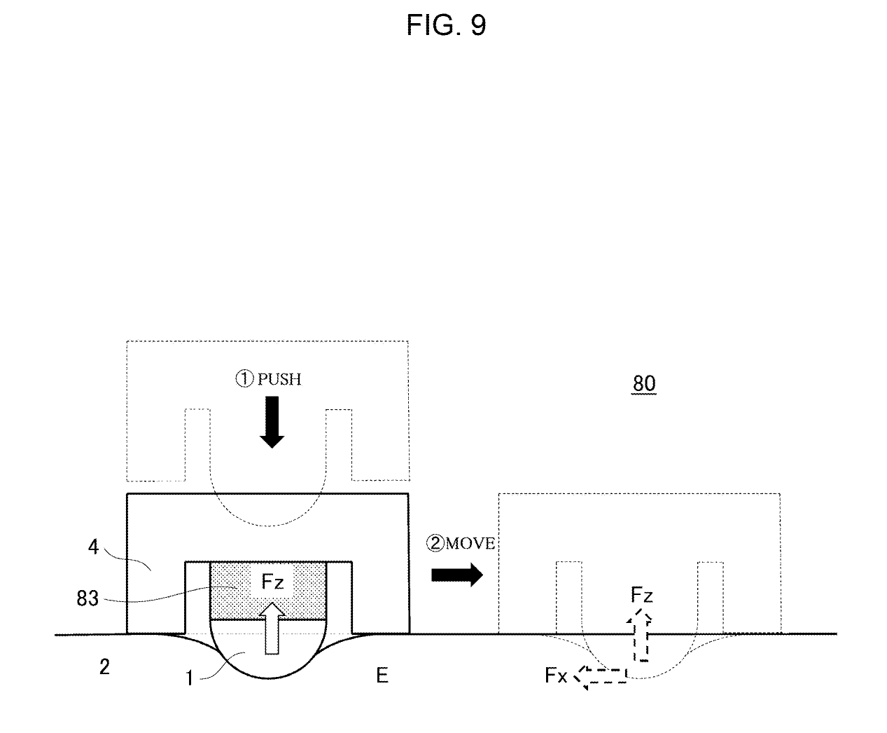

FIG. 9 is a schematic diagram of an indentation unit 80 for measuring two forces of the reaction force Fz generated when the indenter 1 is pushed into the sample 2 and the force Fx generated when the contact surface between the indenter 1 and the sample is moved, using a load cell 83 having sensitivity in two axes of the indentation direction and the direction perpendicular thereto. First, (1) the force Fz generated in the indenter 1 due to the pushing of the indentation unit 83 into the sample is measured, and (2) the force Fx generated when the indentation testing device is transferred (moved) relative to the sample is measured.

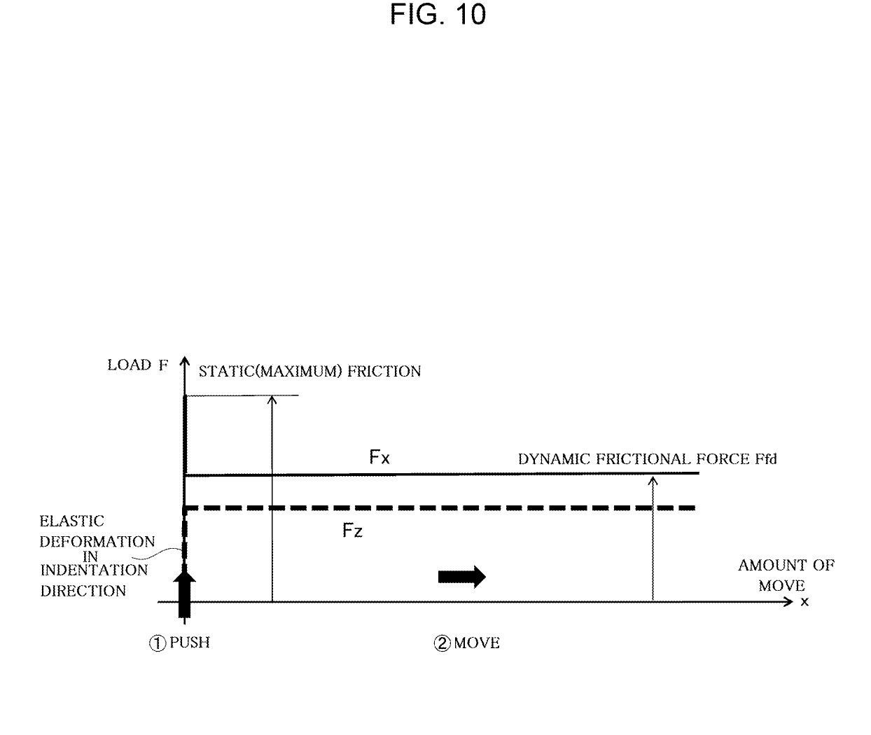

FIG. 10 is a schematic diagram showing changes in the indentation force Fz and the frictional force Fx, which are forces that can be measured by push and move shown in FIG. 9. First, while (1) only the indentation force Fz can be measured when the indentation unit 80 is pushed into the sample 2, (2) the static frictional force Ffs is generated at the moment when the indentation unit 80 is moved relative to the sample 2, and the dynamic frictional force Ffd can be measured during the move of the indentation unit 80.

By the measurement shown in FIGS. 9 and 10, the apparent static friction coefficient μs and the apparent dynamic friction coefficient μd can be determined using Equations 4 and 5 in addition to the Young's modulus E of the sample. Here, “apparent” takes into account that the force due to the compression of the sample 2 is superimposed on Fx in the move shown in FIG. 9. These apparent friction coefficients have the advantage of being closer to the actual feel of the user.

Although a load cell having a biaxial sensitivity is shown as an example, a load cell having a triaxial sensitivity may be used. When the triaxial sensitivity load cell is used, there is the advantage that the apparent static friction coefficient μs and the apparent dynamic friction coefficient μd can be determined regardless of the direction of the contact surface between the device and the sample. When a sensor for measuring the amount of move is used together, there is the advantage that the distribution of these friction coefficients can be determined in addition to the distribution of Young's modulus.

$$\begin{matrix}{μ}_{s} = \frac{{F}_{fs}}{{F}_{z}} & [ Equation 4 ] \\ {μ}_{d} = \frac{{F}_{fd}}{{F}_{z}} & [ Equation 5 ]\end{matrix}$$

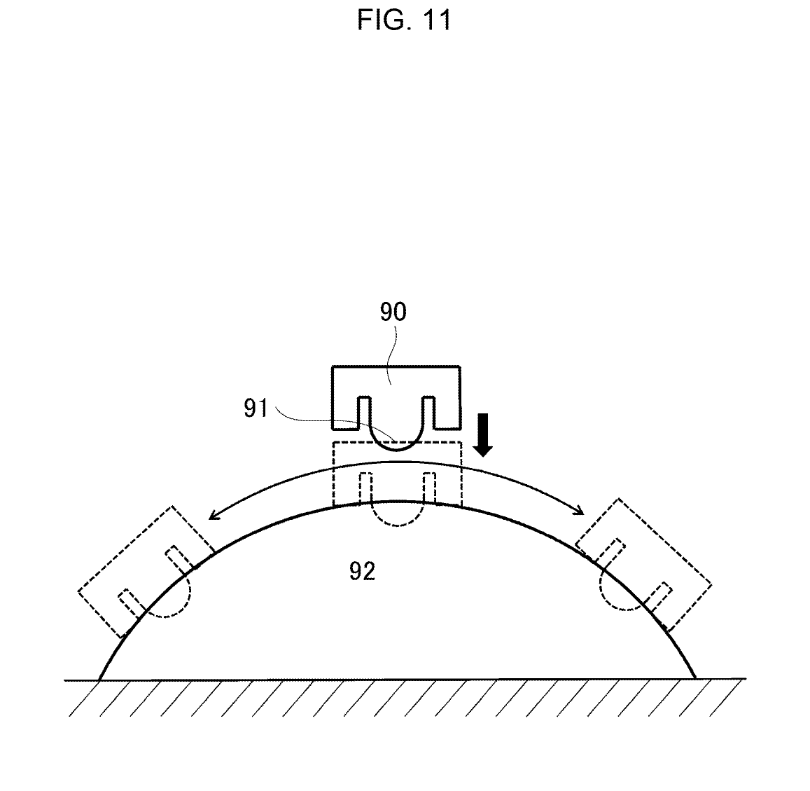

FIG. 11 is a schematic diagram showing a state in which pressing force and frictional force are measured while moving the contact surface between the indentation unit 90 and a sample 92 having a three-dimensional shape. In the device, an indenter 91 is fixed to an indentation unit 90 via a load cell (not shown in the figure). Therefore, it is not necessary to take into account the influence of gravity caused by the change in inclination of the indenter (probe) depending on the direction of the indentation unit 90 as in the case of a conventional device coupled to the indenter 91 by a spring. Therefore, it is also possible to measure the contact surface with the sample having a three-dimensional shape while changing the direction with high accuracy and high speed. When an inclination sensor is used in addition to the sensor for measuring the amount of move, the measurement accuracy is improved.

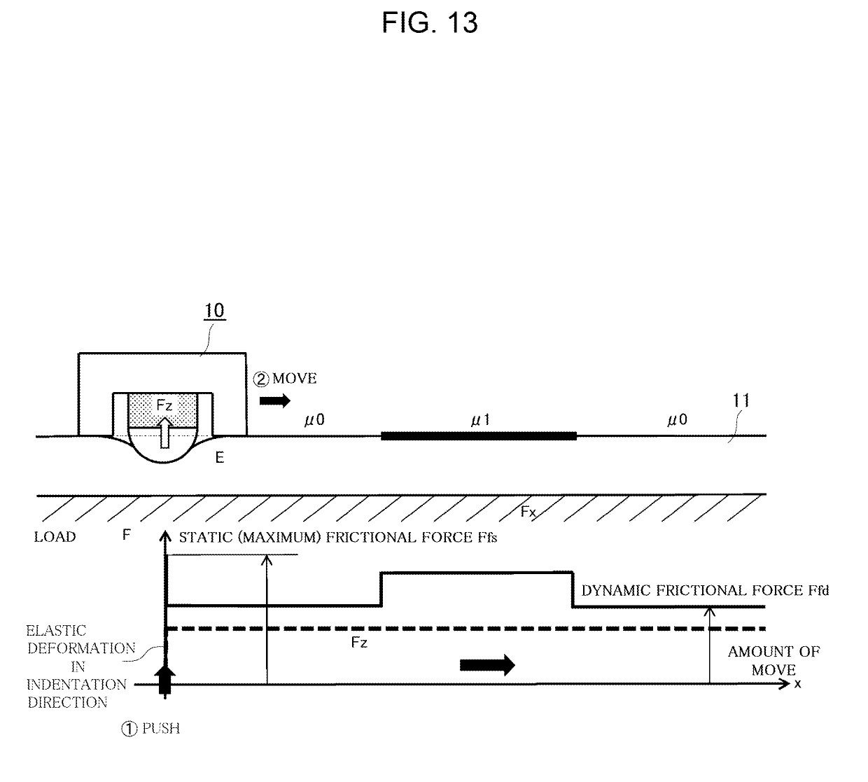

FIG. 13 is a conceptual diagram illustrating a case where a sample 11 the surface friction coefficient of which varies depending on the location is measured. When the Young's modulus E of the sample 11 is uniform throughout, Fz takes a constant value as shown in the figure. On the other hand, when there is a region in which the friction coefficient is higher than μ0 of the other region, a region in which the apparent dynamic friction coefficient Ffd is high is detected corresponding to the output of Fx.

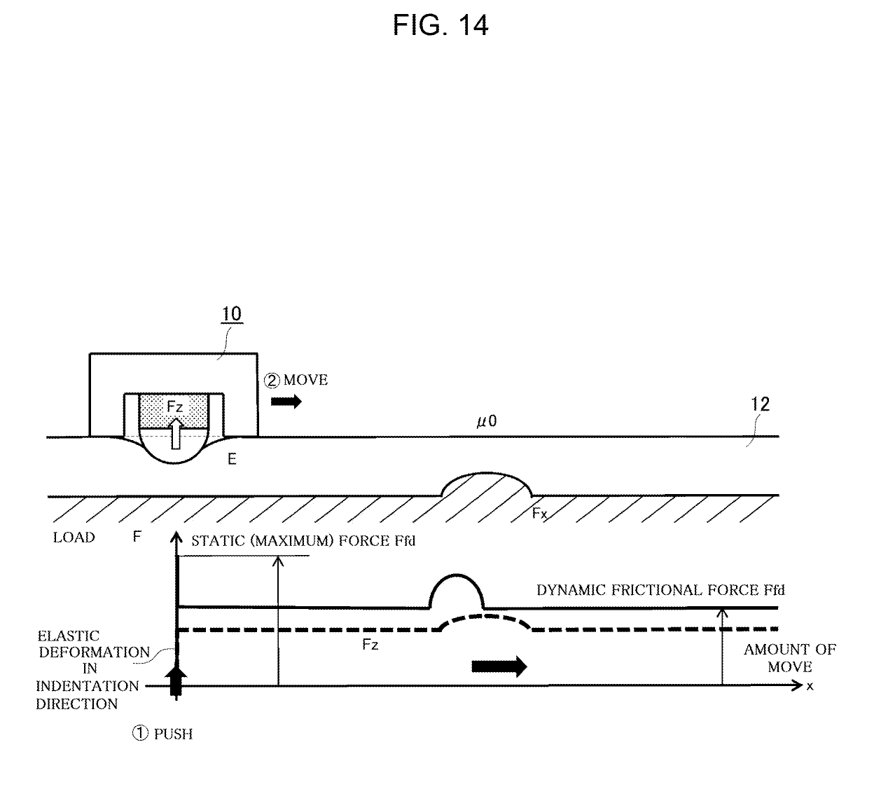

FIG. 14 is a conceptual diagram illustrating a case where a sample 12 that has a uniform surface friction coefficient but has a region having a small thickness is measured. In the part having a small thickness, the value of Fz increases in accordance with the apparent increase in Young's modulus E. In addition, in the region having a small thickness, the force against compression of the sample 12 increases, so that the apparent dynamic friction coefficient Ffd also increases. Therefore, the state of FIG. 13 can be distinguished from the state of FIG. 14 by the combination of Fz and Ffd.

As the sample to be tested by using the indentation testing method and the indentation testing device, polymeric materials including polyurethane, silicone rubber, polyolefin rubber, natural rubber, and soft vinyl, biological tissues including skin and muscle, foods including jelly and gelatin, and the like can be used.

The Young's modulus E of the sample is preferably in the range of 100 Pa to 100 MPa. When the Young's modulus E of the sample is 100 Pa or less, the sample may collapse or break as indentation proceeds. When the Young's modulus E of the sample is 100 Pa or more, there is the advantage that the sample does not collapse or break as indentation proceeds. When the Young's modulus E of the sample is 100 MPa or less, there is the advantage that a soft indenter material can be used and there are many choices of indenter materials.

The spherical indenter can be made of, for example, a metal and/or a resin material. The spherical indenter may be interchangeable. When the sample 2 is very soft, a soft spherical indenter may be used.

The diameter of the spherical indenter is preferably in the range of 1×10⁸ to 1 m. When the thickness of the sample is greater than the diameter of the spherical indenter, there is the advantage that a highly accurate result can be obtained.

Pushing of the spherical indenter can be performed manually or automatically. When the pushing of the spherical indenter is manual, there is the advantage that a measuring machine can be developed at low cost. When the pushing of the spherical indenter is controlled automatically, there is the advantage that the measurement accuracy is stabilized.

The result of the indentation test of the spherical indenter can be digitally displayed by the digital processing function. When the result of the indentation test of the spherical indenter is digitally displayed, there is the advantage that the numerical data of the result can be easily read. When the device has a function capable of digitally processing the result of the indentation test of the spherical indenter, there is the advantage that the measurement result can be easily processed by a computer.

The pushing speed of the spherical indenter is preferably in the range of 0.00001 to 10 m/s. When the pushing speed of the spherical indenter is 0.00001 m/s or more, there is the advantage that the measurement does not take time. When the pushing speed of the spherical indenter is 10 m/s or less, there is the advantage that the device can be operated safely.

The ratio of the amount of indentation of the spherical indenter to the diameter of the spherical indenter is preferably 1 or less. When the ratio is 1 or less, there is the advantage that it is unnecessary to consider a case where the indenter is buried.

As a method for reducing adhesion at the contact surface between the spherical indenter and the sample, a method in which talc powder is applied to the sample contact surface, a method in which oil is applied, and the like can be used. When the adhesion at the contact surface between the spherical indenter and the sample is small, these processes can be omitted.

Although a spherical indenter has been described as a shape of an indenter, the shape of the indenter is not limited thereto. The shape of the indenter may be, for example, a solid cylinder, a hollow cylinder, or a cube.

Since this is fixed to the indenter, a combination of an optical system sensor and a temperature sensor may be used. When an optical system sensor is used, there is the advantage that surface properties of the sample such as surface roughness can also be measured. An example of an optical system sensor is an image sensor such as CMOS. When a temperature sensor is used, there is the advantage that the thermal characteristics of the sample can also be measured. Alternatively, an optical system sensor and a temperature sensor may be provided separately from the indenter.

In the above-described indentation testing method and indentation testing device, the thickness of the sample is identified. The advantage of identifying the thickness of the sample is that the condition of skin, muscle, or the like can be measured while satisfying the non-invasiveness required in human diagnosis.

In either embodiment, a contact sensor may be disposed on the pressing surface 5. In this case, on the basis of the output of the contact sensor, the user may be informed that the pressing surface 5 has come into contact with the sample 2, or the amount δ of indentation when the Young's modulus display unit 21 calculates the Young's modulus E may be determined.

It is needless to say that the present disclosure is not limited to the above-described embodiments, and various other configurations can be adopted without departing from the gist of the present disclosure.

### REFERENCE SIGNS LIST

1 indenter

2 sample

3 load cell

4 enclosure

5 pressing surface

10 indentation unit

20 indentation testing device

21 Young's modulus display unit

22 Poisson ratio display unit

30 indentation testing device

31 signal line

40 indentation testing device

50 indentation testing device

51 PC

62 sample

71, 72 indenter

73 enclosure

74 pressing surface

75, 76 load cell

77 measurement sample

80 indentation unit

83 biaxial sensitivity load cell

90 indentation unit

91 indenter

92 sample

What is claimed is:

1. An indentation testing device that pushes an indenter into a sample, the indentation testing device comprising:
an enclosure having a pressing surface to be pressed against the sample;
the indenter, which is disposed so as to protrude from the pressing surface by a predetermined amount and is pushed into the sample;
a load cell that is disposed between the enclosure and the indenter and that measures at least a force parallel to the indentation direction and acting on the indenter; and
a Young's modulus display unit that calculates and displays the Young's modulus of the sample on the basis of the force acting on the indenter when the pressing surface comes into contact with the sample, as measured with the load cell.

2. The indentation testing device according to claim 1, wherein the indenter is a spherical indenter in which at least a contact part with the sample is spherical.

3. The indentation testing device according to claim 2, wherein, when the diameter of the spherical indenter is denoted by ϕ, the Poisson ratio of the sample is denoted by v, and the amount of protrusion of the spherical indenter from the pressing surface is denoted by δ, the Young's modulus display unit calculates the Young's modulus E of the sample from the measurement of the force F acting on the indenter with the load cell using the following equation:
$$E = \frac{3}{4} ( 1 - {υ}^{2} ) {( \frac{φ}{2} )}^{- \frac{1}{2}} {δ}^{- \frac{3}{2}} F \qquad [ Equation 2 ]$$

4. The indentation testing device according to claim 2, wherein, when the diameter of the spherical indenter is denoted by ϕ, and the Poisson ratio of the sample is denoted by v, the Young's modulus display unit calculates the thinness coefficient B, and the Young's modulus E of the sample that takes into account the thickness of the material, on the basis of a plurality of measured values of the force F measured with the load cell with respect to different amounts δ of protrusion, using the following equation:
$$F = A {\{ ( 1 + B δ ) δ \}}^{\frac{3}{2}} where A = \frac{4}{3} \frac{E}{1 - {v}^{2}} {( \frac{ϕ}{2} )}^{\frac{1}{2}} \qquad [ Equation 3 ]$$

5. The indentation testing device according to claim 1, wherein the load cell also measures a force in a direction perpendicular to the indentation.

6. The indentation testing device according to claim 5, wherein the Young's modulus display unit further calculates and displays the apparent friction coefficient from the Young's modulus E of the sample and the ratio of the force in the pushing direction to the force in the moving direction when the pressing surface is relatively moved while being pressed against the sample.

7. The indentation testing device according to claim 1, further comprising an inclination sensor, wherein the Young's modulus display unit calculates the shape of the sample and the Young's modulus E of the sample on the basis of the force F of the load cell and the inclination from the inclination sensor measured while moving on the surface of the sample having a three-dimensional shape.

8. An indentation testing method in which an indenter is pushed into a sample, the indentation testing method comprising:
until a pressing surface of an enclosure comes into contact with the sample, pushing the indenter, which protrudes from the pressing surface by a predetermined amount, into the sample;
measuring at least a force parallel to the indentation direction and acting on the indenter with a load cell disposed between the enclosure and the indenter; and
calculating the Young's modulus of the sample on the basis of the force acting on the indenter when the pressing surface comes into contact with the sample, as measured with the load cell.

9. The indentation testing method according to claim 8, wherein the indenter is a spherical indenter in which at least a contact part with the sample is spherical.

10. The indentation testing method according to claim 9, wherein, when the diameter of the spherical indenter is denoted by ϕ, the Poisson ratio of the sample is denoted by v, and the amount of protrusion of the spherical indenter from the pressing surface is denoted by δ, the Young's modulus E of the sample is calculated from the measurement of the force F acting on the indenter when the spherical indenter is pushed into the sample by the amount δ of protrusion, using the following equation:
$$E = \frac{3}{4} ( 1 - {υ}^{2} ) {( \frac{φ}{2} )}^{- \frac{1}{2}} {δ}^{- \frac{3}{2}} F \qquad [ Equation 2 ]$$

11. The indentation testing method according to claim 9, wherein, when the diameter of the spherical indenter is denoted by ϕ, and the Poisson ratio of the sample is denoted by v, the thinness coefficient B, and the Young's modulus E of the sample that takes into account the thickness of the material are calculated on the basis of a plurality of measured values of the force F measured with the load cell with respect to different amounts δ of protrusion, using the following equation:
$$F = A {\{ ( 1 + B δ ) δ \}}^{\frac{3}{2}} where A = \frac{4}{3} \frac{E}{1 - {v}^{2}} {( \frac{ϕ}{2} )}^{\frac{1}{2}} \qquad [ Equation 3 ]$$

12. The indentation testing method according to claim 8, wherein the load cell also measures a force in a direction perpendicular to the indentation.

13. The indentation testing method according to claim 12, wherein the apparent friction coefficient is calculated from the Young's modulus E of the sample and the ratio of the force in the pushing direction to the force in the moving direction when the pressing surface is relatively moved while being pressed against the sample.

14. The indentation testing method according to claim 8, wherein the shape of the sample and the Young's modulus E of the sample are measured on the basis of the force F of the load cell and the inclination from the inclination sensor measured while moving on the surface of the sample having a three-dimensional shape.
